(19) United States
(12) Patent Application Publication
(10) Pub. No.: US 2022/0335741 A1
(43) Pub. Date: Oct. 20, 2022

(54) IMAGE ANALYSIS DEVICE, IMAGE ANALYSIS METHOD AND STORAGE MEDIUM STORING IMAGE ANALYSIS PROGRAM

(71) Applicant: MITSUBISHI ELECTRIC CORPORATION, Tokyo (JP)

(72) Inventor: Yusuke ITANI, Tokyo (JP)

(73) Assignee: MITSUBISHI ELECTRIC CORPORATION, Tokyo (JP)

(21) Appl. No.: 17/857,802

(22) Filed: Jul. 5, 2022

Related U.S. Application Data
(63) Continuation of application No. PCT/JP2020/004551, filed on Feb. 6, 2020.

(51) Int. Cl. G06V 30/422; G06V 30/19

(52) U.S. Cl. CPC G06V 30/422; G06V 30/19093; G06N 5/00

(57) ABSTRACT

A drawing image according to drawing data is inputted to an image analysis device. The image analysis device includes a similar image searching unit, an image correspondence detection unit, an attribute output unit, and a knowledge database. The similar image searching unit searches the knowledge database for a drawing image similar to the input drawing image. The image correspondence detection unit detects which of objects and/or their components shown in a drawing image corresponds to which of objects and/or their components shown in the drawing image retrieved by the similar image searching unit. The attribute output unit extracts attribute information of a corresponding point detected by the image correspondence detection unit from the knowledge database to output it as the attribute information of the drawing image.

### CROSS REFERENCE TO RELATED APPLICATIONS

This application is a Continuation of PCT International Application No. PCT/JP2020/004551 filed on Feb. 6, 2020, which is hereby expressly incorporated by reference into the present application.

### TECHNICAL FIELD

This disclosure relates to an image analysis device, an image analysis method, and an image analysis program.

### BACKGROUND TECHNOLOGY

There is a conventional known technique for associating objects, such as machines or placed objects, which are shown in a drawing image such as a blueprint or a layout drawing, and/or their components with attribute information showing their attributes.

For example, Patent Document 1 illustrates the case where components such as utility poles and utility access holes are recognized so as to associate the recognized components with attribute information showing their attributes.

### PRIOR ART LITERATURE

### Patent Documents

[Patent Document 1] Unexamined Patent Application Publication JP, H05-314198

### SUMMARY OF THE INVENTION

### Problems to be Solved by the Invention

The technique disclosed in Patent Document 1 requires, as a prerequisite, that the components shown in the drawing image are represented by their predetermined shapes such as symbols and their predetermined shapes are associated with their attribute information with a one-to-one correspondence. Therefore, the technique disclosed in Patent Document 1 has a problem that in a case where a component is shown with a generic shape such as a circle or a square, the attribute information of the component cannot be uniquely identified from the shape, and as a result, the attribute information of the component cannot be outputted.

The present disclosure is made to solve the above-mentioned problem, and the object is to make it possible to output the attribute information of the objects and/or their components shown in drawing images even in a case where they are shown with generic shapes.

### Solutions

The image analysis device according to this disclosure is an image analysis device that outputs attribute information of an incoming input image, including a similar image searching unit to search for a drawing image similar to the incoming input image in a knowledge database including drawing images and attribute information showing attributes of the drawing images, an image correspondence detection unit to associate a feature point of the drawing image retrieved by the similar image searching unit with a feature point of the input image to detect the feature point of the drawing image as a corresponding point, and an attribute output unit to extract the attribute information of the corresponding point detected by the image correspondence detection unit from the knowledge database to output it as the attribute information of the input image.

### Effects of the Invention

The present disclosure makes it possible to output the attribute information of the objects and/or their components shown in a drawing image even in a case where they are shown with generic shapes.

### BRIEF DESCRIPTIONS OF THE DRAWINGS

FIG. 1 is a block diagram showing a configuration of an image analysis device according to Embodiment 1.

FIG. 2 is a diagram showing an example of an externally inputted drawing image.

FIG. 3 is a diagram showing examples of drawing images stored in a knowledge database.

FIG. 4 is a block diagram showing a configuration of a similar image searching unit.

FIG. 5 is a diagram illustrating an example of extracting feature amounts of a drawing image.

FIG. 6 is a block diagram showing a configuration of an image correspondence detection unit 2.

FIG. 7 is a diagram showing examples of feature points of drawing images.

FIG. 8 is a flowchart showing an operation of the similar image searching unit.

FIG. 9 is a flowchart showing an operation of the image correspondence detection unit.

FIG. 10 is a diagram showing an example of hardware that constitutes the image analysis device.

FIG. 11 is a block diagram showing a configuration of an image analysis device according to Embodiment 2.

FIG. 12 is a block diagram showing a configuration of the similar image searching unit.

### EMBODIMENTS

### Embodiment 1

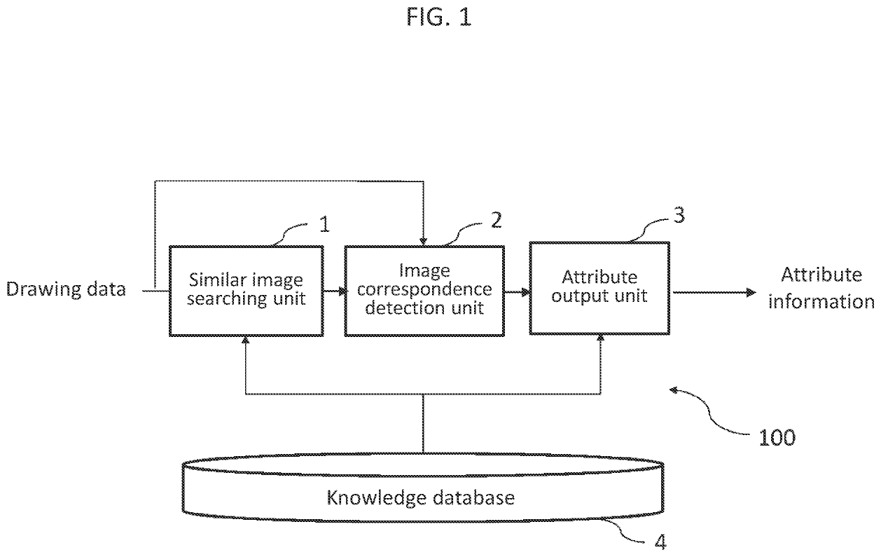

FIG. 1 is a block diagram showing a configuration of an image analysis device 100 according to Embodiment 1. The image analysis device 100 is a device to which a drawing image (an example of input images) according to drawing data is inputted and from which attribute information of the incoming input image is outputted. Specifically, the image analysis device 100 is a device that outputs attribute information of objects shown in a drawing image and/or attribute information of the components of the objects shown therein. Hereinafter, when it is not necessary to distinguish the attribute information of objects from the attribute information of the components of the objects, they are simply referred to as attribute information of a drawing image. The outputted attribute information of a drawing image may include texts showing not only the names of the objects and/or the names of their components but also their model numbers, the created date and updated date of the drawing image, the name of the person who created the drawing image, and the project name for which the drawing image is created. Further, the outputted attribute information of a drawing image may include the dimensions, materials and/or weights of the objects and/or their components.

The image analysis device 100 includes a similar image searching unit 1, an image correspondence detection unit 2, an attribute output unit 3, and a knowledge database 4. The knowledge database 4 stores knowledge data including drawing images and attribute information showing the attributes of the drawing images. The knowledge database 4 may be included in the image analysis device 100 or may be externally connected.

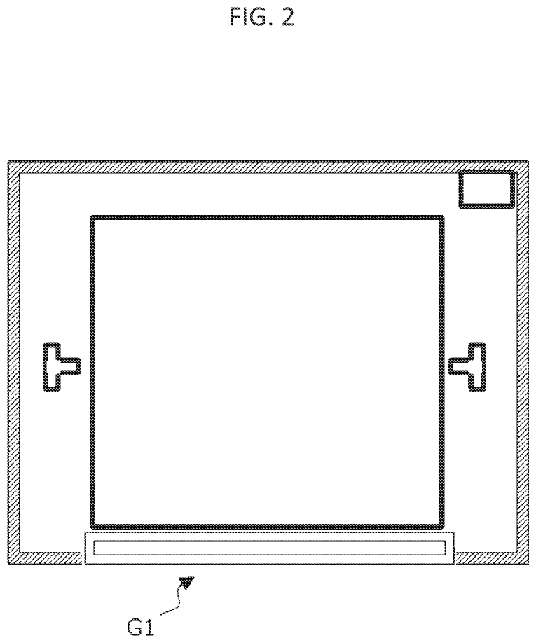

FIG. 2 is a diagram showing an example of an externally inputted drawing image. G1 is a drawing image (an example of input images) that is externally inputted. The drawing image shows the shapes, structures, arrangements, etc. of the objects, such as machines and other placed objects, and/or their components. Further, the drawing image may illustrate a plant, a factory, or a shop as the objects, to show the arrangement of equipment, machines, etc. therein. In the description of the present embodiment, the drawing image is a design drawing of an elevator. In the description of the present embodiment, an elevator is the object, and a hoistway, a car, guide rails, a control panel, and/or a ladder device of the elevator are the components. Also, in the present embodiment, it is supposed that no attribute information is associated with the objects and/or all the components thereof shown in the drawing image. However, the attribute information may be associated with some of the objects and/or their components. The term “associated” here means at least that the correspondence between each of the objects and/or their components shown in the drawing image and their attribute information is uniquely shown. To give a concrete example of the way to show the correspondence therebetween, the attribute information of each of the objects and/or their components shown in the drawing image may be provided by using a leader line.

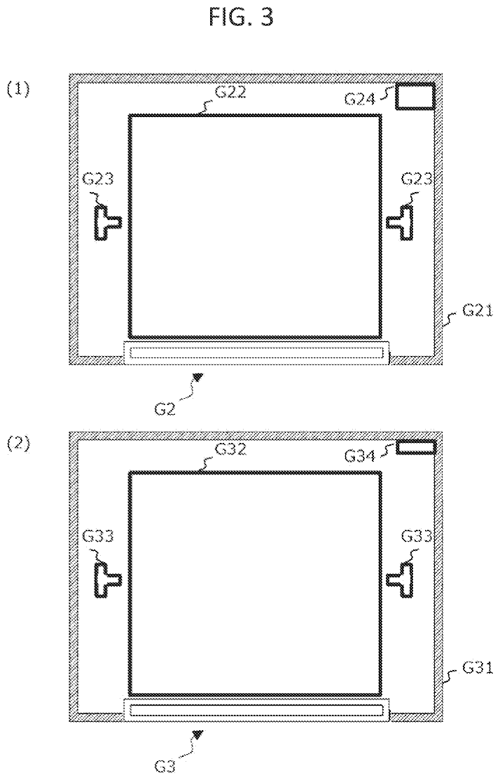

FIG. 3 is a diagram showing examples of drawing images stored in the knowledge database 4. G2 and G3 are drawing images stored in the knowledge database 4. G21 to G24 are the components shown in the drawing image G2. G31 to G34 are the components shown in the drawing image G3. Now suppose that an attribute “hoistway” is associated with the components G21 and G31; an attribute “elevator car” is associated with the components G22 and G32; an attribute “guide rail” is associated with the components G23 and G33; an attribute “control panel” is associated with the components G24; and an attribute “ladder device” is associated with the components G34. In the present embodiment, it is supposed that all the components shown in the drawing images are each associated with their attribute information. However, the attribute information may be associated with the components in part. Note that, in the knowledge database 4, the images showing the objects and/or their components and their attribute information may be stored in association with each other.

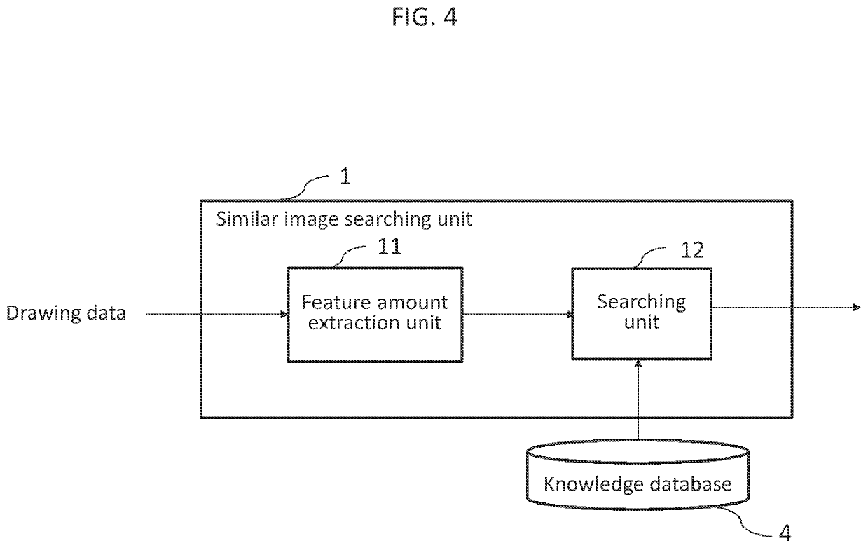

FIG. 4 is a block diagram showing a configuration of the similar image searching unit 1. The similar image searching unit 1 includes a feature amount extraction unit 11 and a searching unit 12 and searches the knowledge database 4 for a drawing image similar to the inputted drawing image. The feature amount extraction unit 11 extracts a feature amount of the inputted drawing image G1 using histograms of oriented gradients (HOG) or a graph kernel algorithm to output the extracted feature amount to the searching unit 12.

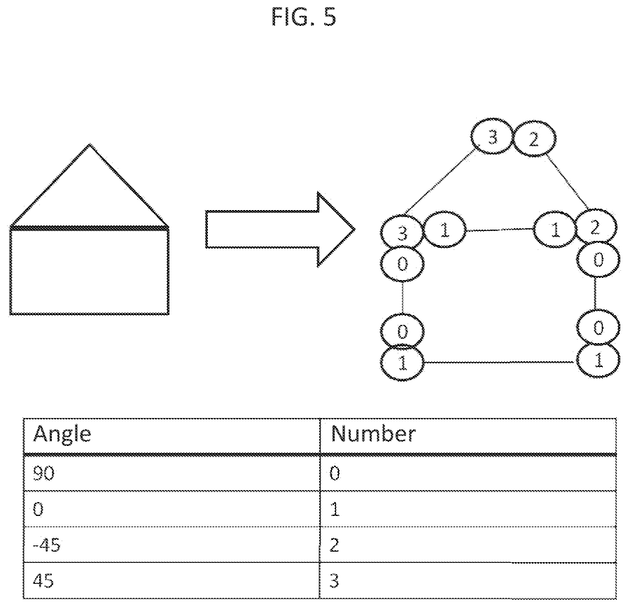

FIG. 5 is a diagram illustrating an example of extracting a feature amount of a drawing image. The feature amount extraction unit 11 gives an identifier to each vertex of the objects and/or their components shown in the drawing image. The feature amount extraction unit 11 may give numbers as identifiers showing features of a vertex such as an angle formed at the vertex, the length and the thickness of the line segment connecting the vertexes, for example, as shown in FIG. 5. In FIG. 5, the identifiers are given only to the vertexes. However, it is possible to generate nodes for all the pixels or a part of the pixels forming a line segment to give identifiers to the nodes. Giving identifiers to many pixels makes it possible to improve the accuracy in specifying a feature of a component. However, since the load for subsequent processing increases, it should be decided according to the hardware resources and so on.

Now, the description returns to FIG. 4. The searching unit 12 calculates the degrees of similarity between the feature amount extracted from the drawing image G1 and the feature amount extracted from each of the drawing images stored in the knowledge database 4. The searching unit 12 sorts the drawing images stored in the knowledge database 4 according to the degrees of similarity to output the drawing images to the image correspondence detection unit 2 in order of the degree of similarity from high to low. In the present embodiment, it is supposed that the searching unit 12 outputs G2 in FIG. 3 to the image correspondence detection unit 2 as a drawing image having a high degree of similarity. The feature amounts which are extracted from the drawing images stored in the knowledge database 4 may be included in the knowledge data in advance or may be extracted by the feature amount extraction unit 11 one by one.

Meanwhile, in a case where the feature amount of the drawing image G1 is vectorized, the searching unit 12 may obtain the degree of similarity using the cosine degree of similarity, as shown in Formula 1 for example, to output the drawing images to the image correspondence detection unit 2 in order of the degree of similarity from high to low.

S=(f×g)/(|f| |g|) Formula (1)

S is the degree of similarity, f is the feature amount obtained from the drawing image G1, and g is the feature amount of a drawing image included in the knowledge data.

Further, when the feature amount is extracted by the feature amount extraction unit 11 using the graph kernel algorithm, the searching unit 12 may calculate the degree of similarity using an analysis estimation algorithm such as that used in Non-Patent Document 1. Non-Patent Document 1: N. Shervashidze et al., “Weisfeiler-Lehman Graph Kernels,” JMLR, vol. 12, pp. 2539-2561, 2011.

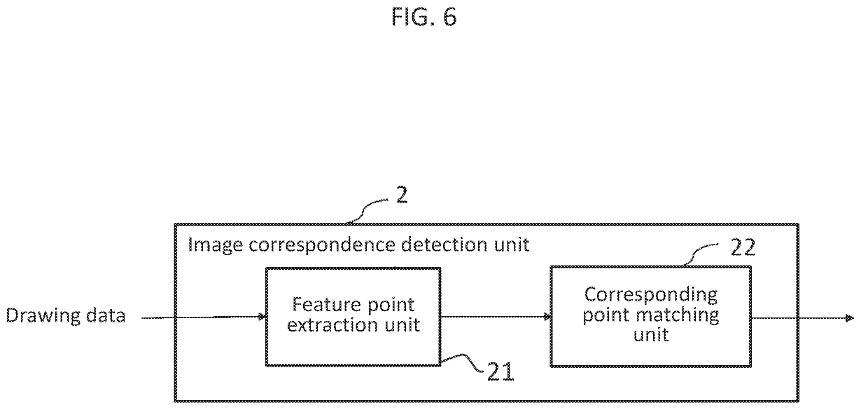

FIG. 6 is a block diagram showing a configuration of the image correspondence detection unit 2. The image correspondence detection unit 2 includes a feature point extraction unit 21 and a corresponding point matching unit 22 and thereby associates the feature points of a drawing image retrieved by the similar image searching unit 1 with the feature points of the inputted drawing image to obtain the associated feature points as corresponding points.

The feature point extraction unit 21 extracts the feature points of the objects and/or their components shown in the drawing image G1 by using local feature amounts such as HOG. The feature point extraction unit 21 extracts the vertexes forming the objects and/or their components as their feature points. The feature point extraction unit 21 may further extract, as the feature points, branch points and/or end points forming the objects and/or their components. The feature point extraction unit 21 outputs information showing the extracted feature points to the corresponding point matching unit 22.

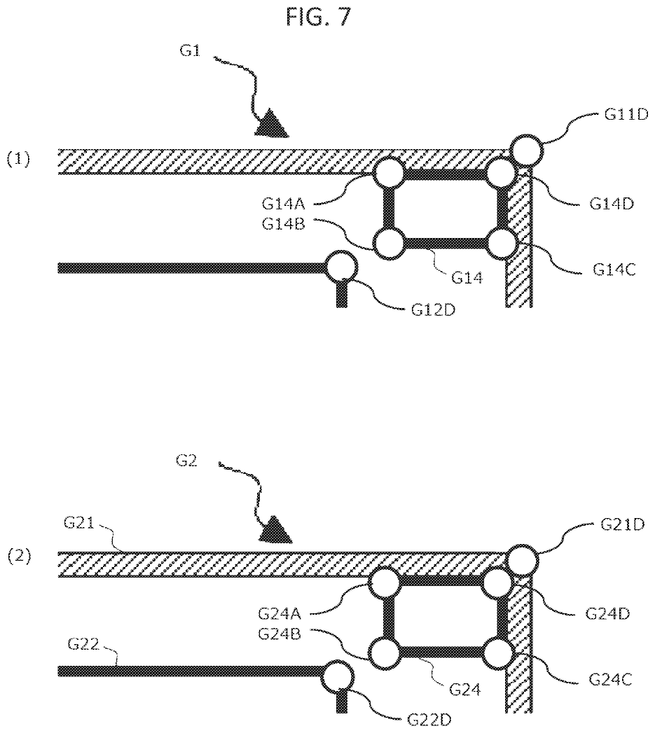

FIG. 7 is a diagram showing the feature points of the drawing images. In FIG. 7 (1), G14A to G14D, G12D, and G11D are shown as the feature points of the drawing image G1. Also, in FIG. 7 (2), G24A to G24D are shown as the feature points of the component G24 of the drawing image G2. Further, G22D is shown as the feature point of the component G22 forming the drawing image G2, and G21D is shown as the feature point of the component G21 forming the drawing image G2.

The corresponding point matching unit 22 calculates the distance between a feature point of the drawing image G2 retrieved by the similar image searching unit 1 and a feature point of the drawing image G1 extracted by the feature point extraction unit 21 to detect the feature points whose distance is short as the corresponding point. The corresponding point matching unit 22 outputs the information showing the detected corresponding points to the attribute output unit 3.

The corresponding point matching unit 22 calculates the distance between the feature points based on, for example, Formula (2).

d=∥f·g∥² Formula (2)

Here, d is the distance between feature points, f is the feature amount of a feature point of the drawing image G1, and g is the feature amount of a feature point of the drawing image G2. For the feature amounts of feature points, the feature amounts extracted by the feature amount extraction unit 11 may be used. The feature amounts of the feature points of the drawing image G2 may be stored in advance in the knowledge database 4.

In this Embodiment, the corresponding point matching unit 22 detects G24A as the corresponding point of the feature point G14A, G24B as the corresponding point of the feature point G14B, G24C as the corresponding point of the feature point G14C, and G24D as the corresponding point of the feature point G14D to output the information showing the detected corresponding points G24A, G24B, G24C, and G24D to the attribute output unit 3.

The attribute output unit 3 extracts, from the knowledge database 4, the attribute information matching the corresponding points detected by the image correspondence detection unit 2 to output it as the attribute information of the drawing image G1. Specifically, the attribute output unit 3 identifies the component G24 of the drawing image G2 as the object or component that is consistent with the corresponding points G24A, G24B, G24C, and G24D outputted from the corresponding point matching unit 22 of the image correspondence detection unit 2. Further, the attribute output unit 3 extracts the attribute information (control unit) of the component G24 of the drawing image G2 from the knowledge database 4. Then, the attribute output unit 3 outputs “control device” extracted from the knowledge database 4 as the attribute information of a component G14, of the drawing image G1, represented by the feature points G14A, G14B, G14C, and G14D.

The image analysis device 100 may include a knowledge data update unit (not shown). The knowledge data update unit may store, in the knowledge database 4, the knowledge data in which the object and/or its component of the drawing image and the attribute information outputted from the attribute output unit 3 are associated with each other.

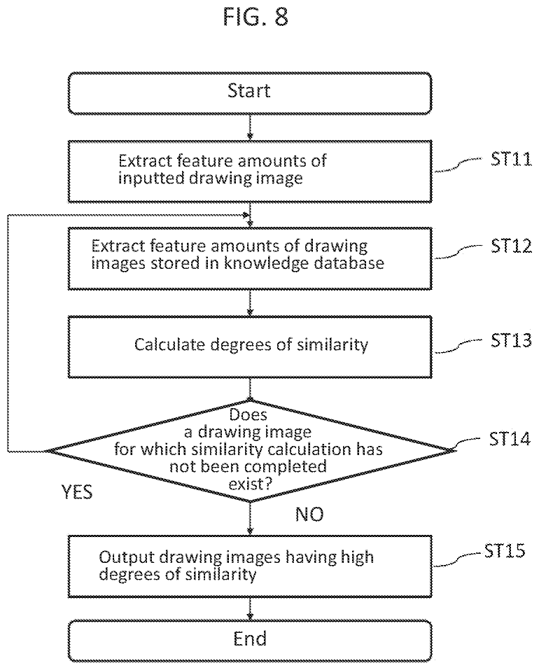

FIG. 8 is a flowchart showing operation of the similar image searching unit 1. The feature amount extraction unit 11 of the similar image searching unit 1 extracts the feature amounts of the inputted drawing image G1 (ST11).

The searching unit 12 of the similar image searching unit 1 extracts the feature amounts of the drawing images stored in the knowledge database 4 (ST12). Further, the searching unit 12 calculates the degrees of similarity based on the feature amount of the drawing image G1 extracted in ST11 and the feature amounts of the drawing images extracted in ST12 (ST13).

The searching unit 12 repeats ST12 and ST13 until a drawing image whose degree of similarity has not been calculated disappears in the knowledge database 4 (ST14).

The searching unit 12 sorts the drawing images stored in the knowledge database 4 by the degree of similarity to output them to the image correspondence detection unit 2 in order of the degree of similarity from high to low (ST15).

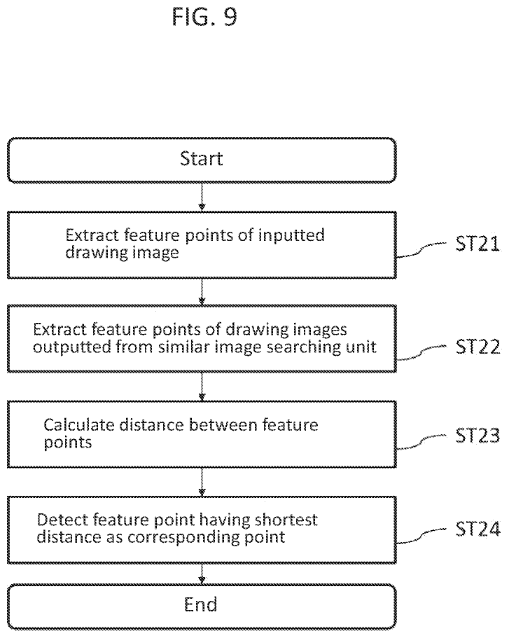

FIG. 9 is a flowchart showing an operation of the image correspondence detection unit 2. The feature point extraction unit 21 of the image correspondence detection unit 2 extracts the feature points from the inputted drawing image G1 (ST21).

The feature point extraction unit 21 of the image correspondence detection unit 2 extracts the feature points of the drawing image G2 retrieved by the similar image searching unit 1 (ST22).

The corresponding point matching unit 22 of the image correspondence detection unit 2 calculates the distances between the feature points of the drawing image G2 retrieved by the similar image searching unit 1 and the feature points of the inputted drawing image G1 (ST23). Further, the corresponding point matching unit 22 detects, as the corresponding point, a feature point of the drawing image G2 with a short distance to output the information showing the detected corresponding points to the attribute output unit 3 (ST24).

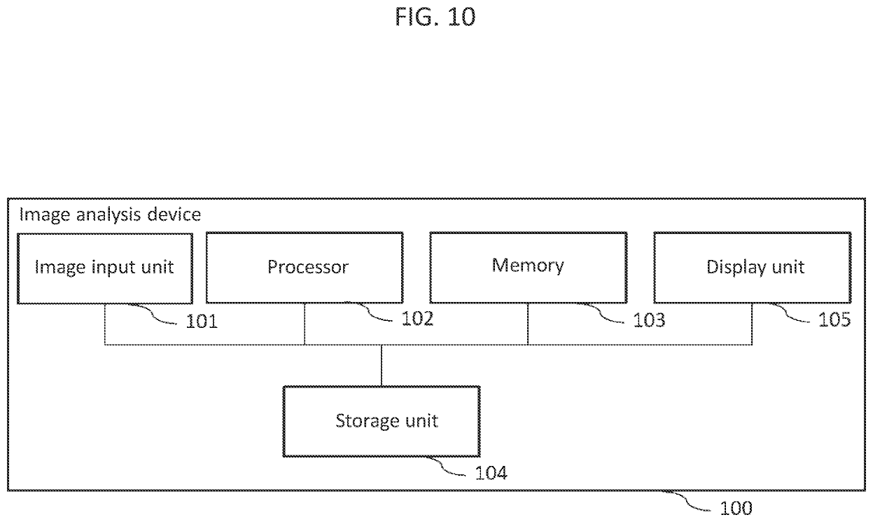

FIG. 10 is a diagram showing an example of hardware that constitutes the image analysis device 100. An image input unit 101 is an interface for externally inputting image data to the image analysis device 100. The image input unit 101 is, for example, a scanner or a camera, and reads a printed image from a printed material and inputs the digital image data to the image analysis device 100. A processor 102 realizes the functions of the similar image searching unit 1, the image correspondence detection unit 2, and the attribute output unit 3 shown in FIG. 1 by executing a program stored in a memory 103. The memory 103 is, for example, a non-volatile memory, and stores various programs to be executed by the processor 102. Further, the processor 102 and the memory 103 may be realized by hardware such as a processing circuit. A storage unit 104 stores various data (knowledge data, programs, etc.) to be processed by the processor 102. A display unit 105 is, for example, a liquid crystal display, and displays the attribute information etc outputted from the processor 102. The storage unit 104 and/or the display unit 105 may be included in the image analysis device 100 or may be externally provided.

As described above, according to the present embodiment, the image analysis device 100 can output attribute information to be given to a new incoming input image based on the drawing images and the attribute information showing the attributes of the drawing images stored in the knowledge database 4. Therefore, this makes it possible to help to give the attribute information to the objects and/or their components shown in the input image.

### Embodiment 2

In Embodiment 2, in order for the image analysis device 100 to reduce its processing load while it maintains high accuracy in outputting the attribute information of the components shown in the drawing image, the image analysis device 100 can receive, as an external input, not only a drawing image but also a text related to the attribute information of the drawing image.

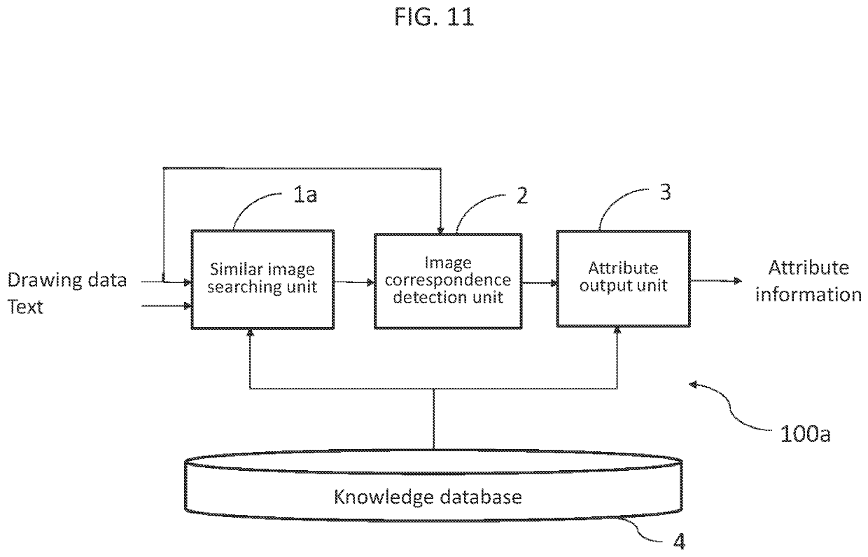

FIG. 11 is a block diagram showing a configuration of an image analysis device according to Embodiment 2. An image analysis device 100a includes a similar image searching unit 1a, the image correspondence detection unit 2, the attribute output unit 3, and a knowledge database 4. Since the image correspondence detection unit 2 and the attribute output unit 3 are the same as those in Embodiment 1, the description thereof will be omitted.

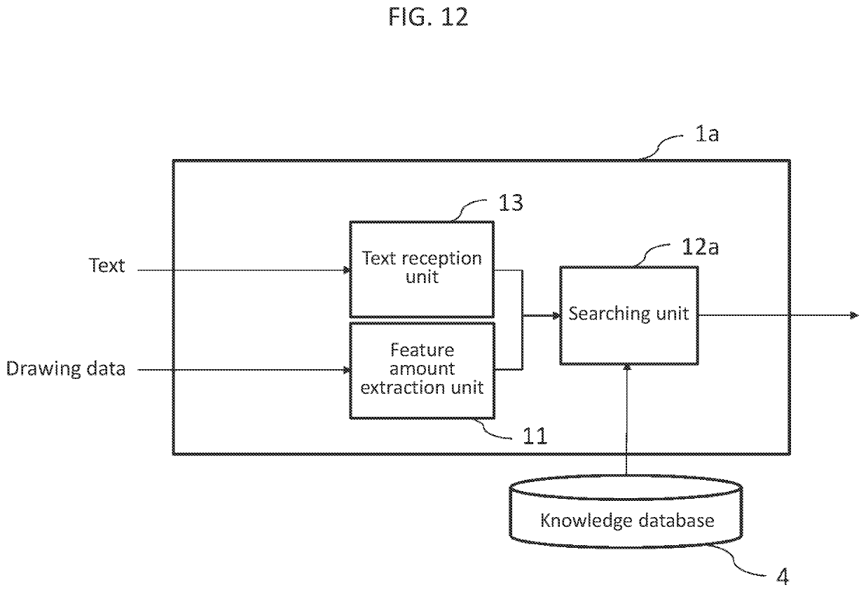

FIG. 12 is a block diagram showing a configuration of the similar image searching unit according to Embodiment 2. The similar image searching unit 1a includes the feature amount extraction unit 11, a searching unit 12a, and a text reception unit 13. The text reception unit 13 receives an external input of a text to output the received text to the searching unit 12a. Here, instead of outputting the received text as it is to the searching unit 12a, the text reception unit 13 may decompose the received text into minimum units that each carry a meaning using a well-known morphological analysis technique to output the decomposed units to the searching unit 12a. Further, instead of outputting the received text as it is to the searching unit 12a, the text reception unit 13 may extract synonyms of words in the received text from a thesaurus (synonym dictionary) to output the synonyms to the searching unit 12a. As a result, the searching unit 12a can search images not only by the exact wording of the inputted text but also by various terms, so that the drawing images associated with more appropriate attribute information can be extracted. For example, in a case where an externally inputted text includes an expression “elevator door”, the text reception unit 13 decomposes the expression into “elevator” and “door” to output the word of “lift” with its synonym “elevator” and the word of “door” with its synonym “gate” to the searching unit 12a.

In a case where an externally inputted text includes a word “elevator”, the searching unit 12a searches the knowledge database 4 for drawing images whose attribute information relates to the word “elevator” and which is similar to the input drawing image G1. In this way, the similar image searching unit 1a narrows down the drawing images to be extracted from the knowledge database 4 by using the input text, so that the attribute information of the components shown in the drawing image can be outputted with high accuracy while the processing load on the image analysis device 100 is kept low.

### Other Modifications

The embodiments described above are only examples of implementation of the present disclosure, and application examples that include the following additions/changes in the configurations can be conceivable.

In the above-described embodiments, the searching unit 12 of the similar image searching unit 1 sorts the drawing images stored in the knowledge database 4 by the degree of similarity and outputs them to the image correspondence detection unit 2 in order of the degree of similarity from high to low. However, not limited to the above, the searching unit 12 may output the drawing image having a degree of similarity equal to or higher than a threshold value to the image correspondence detection unit 2. For example, suppose that the range of degree of similarity is represented by numerical values from 0 to 100 and the larger numerical value means the larger degree of similarity. A threshold for determining the similarity is set in advance. The searching unit 12 may sort the drawing images stored in the knowledge database 4 in descending order of the degree of similarity, search for the drawing images having degrees of similarity equal to or higher than the preset threshold value, and output the retrieved drawing images to the image correspondence detection unit 2. Then, the image correspondence detection unit 2 may calculate the distances between the feature points of all the drawing images outputted from the similar image searching unit 1 and the feature points of the input image and detect a feature point with a short distance of the drawing image as a corresponding point.

Further, the searching unit 12 may be configured so as to lower the threshold value as the number of the components shown in the drawing image G1 increases. By doing so, searching the drawing images that include the components corresponding to the components shown in the drawing image G1 in the knowledge database 4 becomes easy. Further, instead of using a threshold value, the searching unit 12 may output the drawing images to the image correspondence detection unit 2 in descending order of the degree of similarity as many as a preset number.

In this case, the searching unit 12 may be configured so as to increase the number of the drawing images to be outputted to the image correspondence detection unit 2 as the number of the components shown in the drawing image G1 increases. By doing so, searching the drawing images that include the components corresponding to the components shown in the drawing image G1 in the knowledge database 4 becomes easy.

In the above-described embodiments, the attribute information of the component G14 is outputted based on the attribute information of the component G24 having the same shape as or similar shape to the component G14 of the drawing image G1. However, this is not the limitation. The image correspondence detection unit 2 may output the attribute information of not only the component with the same or similar shape but also the component which has feature point with a short feature distance.

### DESCRIPTION OF SYMBOLS

1 similar image searching unit,
11 feature amount extraction unit,
12 searching unit,
2 image correspondence detection unit,
21 feature point extraction unit,
22 corresponding point matching unit,
3 attribute output unit,
4 knowledge database,
100 image analysis device,
101 image input unit,
102 processor,
103 memory,
104 storage unit,
105 display unit

1. An image analysis device that outputs attribute information of an incoming input image, comprising:
similar image searching circuitry to search for a drawing image similar to the incoming input image in a knowledge database including drawing images and attribute information showing attributes of the drawing images;
image correspondence detection circuitry to associate a feature point of the drawing image retrieved by the similar image searching circuitry with a feature point of the input image to detect the feature point of the drawing image as a corresponding point; and
attribute output circuitry to extract the attribute information of the corresponding point detected by the image correspondence detection circuitry from the knowledge database to output it as the attribute information of the input image.

2. The image analysis device according to claim 1, wherein the image correspondence detection circuitry calculates a distance between the feature point of the drawing image retrieved by the similar image searching circuitry and the feature point of the input image to detect, as the corresponding point, the feature point of the drawing image whose distance is short.

3. The image analysis device according to claim 1, wherein the image correspondence detection circuitry uses a vertex and/or branch point of an object and/or its component shown in the input image as the feature point.

4. The image analysis device according to claim 2, wherein the image correspondence detection circuitry uses a vertex and/or branch point of an object and/or its component shown in the input image as the feature point.

5. The image analysis device according to claim 1, wherein the similar image searching circuitry searches for a drawing image similar to the input image in the feature amount extracted based on angles at vertices and/or lengths of line segments connecting the vertices, the vertices forming the input image.

6. The image analysis device according to claim 2, wherein the similar image searching circuitry searches for a drawing image similar to the input image in the feature amount extracted based on angles at vertices and/or lengths of line segments connecting the vertices, the vertices forming the input image.

7. The image analysis device according to claim 3, wherein the similar image searching circuitry searches for a drawing image similar to the input image in the feature amount extracted based on angles at vertices and/or lengths of line segments connecting the vertices, the vertices forming the input image.

8. The image analysis device according to claim 4, wherein the similar image searching circuitry searches for a drawing image similar to the input image in the feature amount extracted based on angles at vertices and/or lengths of line segments connecting the vertices, the vertices forming the input image.

9. The image analysis device according to claim 1, wherein the input image is inputted together with a text related to the attribute information of the input image and the similar image searching circuitry searches the knowledge database for a drawing image whose attribute information relates to the text and which is similar to the input image.

10. The image analysis device according to claim 2, wherein the input image is inputted together with a text related to the attribute information of the input image and the similar image searching circuitry searches the knowledge database for a drawing image whose attribute information relates to the text and which is similar to the input image.

11. The image analysis device according to claim 3, wherein the input image is inputted together with a text related to the attribute information of the input image and the similar image searching circuitry searches the knowledge database for a drawing image whose attribute information relates to the text and which is similar to the input image.

12. The image analysis device according to claim 4, wherein the input image is inputted together with a text related to the attribute information of the input image and the similar image searching circuitry searches the knowledge database for a drawing image whose attribute information relates to the text and which is similar to the input image.

13. The image analysis device according to claim 5, wherein the input image is inputted together with a text related to the attribute information of the input image and the similar image searching circuitry searches the knowledge database for a drawing image whose attribute information relates to the text and which is similar to the input image.

14. The image analysis device according to claim 6, wherein the input image is inputted together with a text related to the attribute information of the input image and the similar image searching circuitry searches the knowledge database for a drawing image whose attribute information relates to the text and which is similar to the input image.

15. The image analysis device according to claim 7, wherein the input image is inputted together with a text related to the attribute information of the input image and the similar image searching circuitry searches the knowledge database for a drawing image whose attribute information relates to the text and which is similar to the input image.

16. The image analysis device according to claim 8, wherein the input image is inputted together with a text related to the attribute information of the input image and the similar image searching circuitry searches the knowledge database for a drawing image whose attribute information relates to the text and which is similar to the input image.

17. A storage medium storing an image analysis program which, when it is executed by circuitry, performs processes of:
searching for a drawing image similar to an incoming input image in a knowledge database including drawing images and attribute information showing attributes of the drawing images;
calculating a distance between a feature point of the drawing image retrieved by the searching and a feature point of the input image to detect the feature point of the retrieved drawing image whose distance is short as a corresponding point; and
extracting the attribute information of the corresponding point detected by the detecting from the knowledge database to output it as the attribute information of the input image.

18. An image analysis method for outputting attribute information of an incoming input image, the method comprising:
searching for a drawing image similar to the incoming input image in a knowledge database including drawing images and attribute information showing attributes of the drawing images;
associating a feature point of the retrieved drawing image with a feature point of the input image to detect the feature point of the drawing image as a corresponding point; and
extracting the attribute information of the detected corresponding point from the knowledge database to output it as the attribute information of the input image.
